(19) United States
(12) Patent Application Publication
(10) Pub. No.: US 2016/0195992 A1
(43) Pub. Date: Jul. 7, 2016

(54) MOBILE TERMINAL AND METHOD FOR PROCESSING SIGNALS GENERATED FROM TOUCHING VIRTUAL KEYS

(71) Applicant: Xiaomi Inc., Beijing (CN)

(72) Inventors: Zhongsheng JIANG, Beijing (CN); Kun YANG, Beijing (CN); Jun TAO, Beijing (CN)

(73) Assignee: Xiaomi Inc.

(21) Appl. No.: 15/065,142

(22) Filed: Mar. 9, 2016

Related U.S. Application Data
(63) Continuation of application No. PCT/CN2015/093409, filed on Oct. 30, 2015.

(30) Foreign Application Priority Data
Jan. 7, 2015 (CN) 201510008097.5
Jan. 19, 2015 (CN) 201510025615.4

(51) Int. Cl. G06F 3/041; G06F 3/0488

(52) U.S. Cl. CPC G06F 3/0416; G06F 3/04886; G06F 3/04883

(57) ABSTRACT

A mobile terminal includes: a touch panel including a plurality of virtual keys and a first auxiliary sensing area, wherein the first auxiliary sensing area is located on one side of the touch panel; and a touch processing circuit coupled to the touch panel, the touch processing circuit being configured to receive triggers of at least two virtual keys and the first auxiliary sensing area and process a trigger of a first one of the at least two virtual keys that is located farther away from the first auxiliary sensing area.

### CROSS-REFERENCE TO RELATED APPLICATIONS

This application is a continuation application of International Application No. PCT/CN2015/093409, filed with the State Intellectual Property Office of P. R. China on Oct. 30, 2015, which is based upon and claims priority to Chinese Patent Application No. 201510025615.4 filed on Jan. 19, 2015, and Chinese Patent Application No. 201510008097.5, filed on Jan. 7, 2015, the entire contents of all of which are incorporated herein by reference.

### TECHNICAL FIELD

The present disclosure relates to the field of computer processing, and more particularly, to a mobile terminal and a method for processing signals generated from touching virtual keys.

### BACKGROUND

Due to the development of electronic technology, mobile terminals have been widely used and upgraded quickly. Conventionally, a mobile terminal is provided with a keyboard as an input apparatus. Recently, a mobile terminal is provided with a touch screen or a more advanced full touch screen as an input apparatus, and becomes more and more intelligent. A lot of functions of physical keys may be realized by the virtual keys in the touch screen of a mobile terminal. The user may perform operations on the mobile terminal via touching the virtual keys or applying other gestures on the virtual keys.

### SUMMARY

According to a first aspect of the present disclosure, there is provided a mobile terminal. The mobile terminal includes: a touch panel including a plurality of virtual keys and a first auxiliary sensing area, wherein the first auxiliary sensing area is located on one side of the touch panel; and a touch processing circuit coupled to the touch panel, the touch processing circuit being configured to receive triggers of at least two virtual keys and the first auxiliary sensing area and process a trigger of a first one of the at least two virtual keys that is located farther away from the first auxiliary sensing area.

According to another aspect of the present disclosure, there is provided a method for processing signals generated from touching virtual keys of a touch panel. The method includes: acquiring triggers of at least two virtual keys and an auxiliary sensing area of the touch panel; and processing a trigger of a first one of the at least two virtual keys that is located farther away from the auxiliary sensing area.

According to another aspect of the present disclosure, there is provided a device for processing signals generated from touching virtual keys of a touch panel. The device includes a processor, and a memory for storing instructions executable by the processor. The processor is configured to: acquire triggers of at least two virtual keys and an auxiliary sensing area of the touch panel; and process a trigger of a first one of the at least two virtual keys that is located farther away from the auxiliary sensing area.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 shows a mobile terminal in the related art.

FIG. 2 shows a mobile terminal according to an exemplary embodiment of the present disclosure.

FIG. 3 shows another mobile terminal according to an exemplary embodiment of the present disclosure.

FIG. 4 shows yet another mobile terminal according to an exemplary embodiment of the present disclosure.

FIG. 5A is a flow chart showing a method for processing a signal generated from touching a virtual key according to an exemplary embodiment of the present disclosure.

FIG. 5B is a flow chart showing details of step 501 shown in FIG. 5A, according to an exemplary embodiment of the present disclosure.

FIG. 6A is a block diagram showing a device for processing a signal generated from a virtual key according to an exemplary embodiment of the present disclosure.

FIG. 6B is a block diagram showing details of the acquiring module shown in FIG. 6A according to an exemplary embodiment of the present disclosure.

FIG. 7 is a block diagram showing a device according to an exemplary embodiment of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

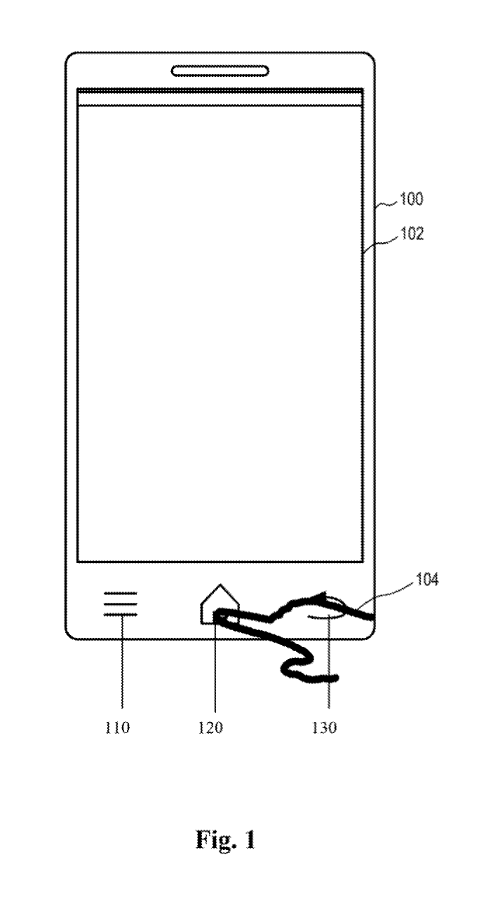

In the related art, a mobile terminal is provided with a touch screen. Virtual keys on the touch screen may be used to realize functions of physical keys. While the physical keys are selected by pressing the keys, the virtual keys may be triggered via sensing a touch. However, there may be a problem in the sensing process. FIG. 1 shows a mobile terminal 100 including a touch screen 102 and left, middle, and right virtual keys 110, 120, and 130 disposed on the touch screen 102. When a user holds the mobile terminal with his/her right hand, and wishes to touch the left key 110 using a finger of his/her right hand, the user may inadvertently touch the middle key 120 and/or the right key 130, as shown by a motion track 104 of the user's finger movement in FIG. 1. As a result, the mobile terminal 100 may process the incorrect selection of the key 120 or the key 130.

In order to solve this problem, a touch panel consistent with embodiments of the present disclosure may be provided with an auxiliary touch-sensing area. The processing priority of triggers on the virtual keys may be adjusted by sensing a touch on the auxiliary touch-sensing area, which reduces the possibility of incorrect processing.

Consistent with embodiments of the present disclosure, the virtual keys may include virtual keys for a display interface, menu keys in a control area, a home key, and a back key. Further, the present disclosure contemplates all virtual keys that are capable of receiving input from a user by sensing a touch.

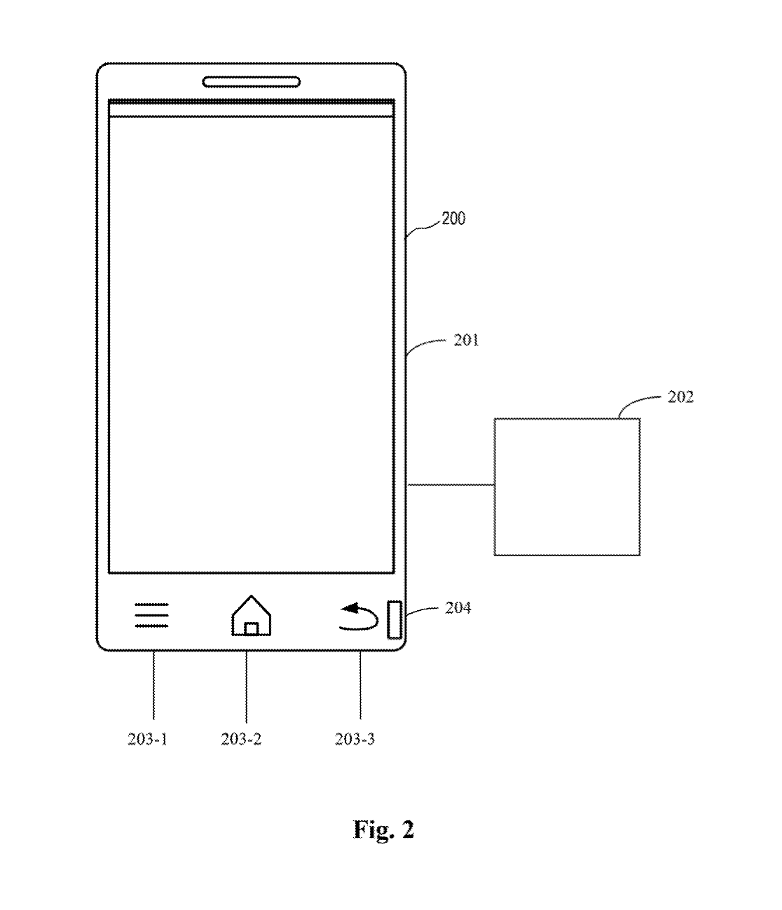

FIG. 2 shows a mobile terminal 200 according to an example embodiment of the present disclosure. As shown in FIG. 2, the mobile terminal 200 includes a touch panel 201 and a touch processing circuit 202, such as a touch processing chip.

The touch panel 201 includes a plurality of virtual keys 203 and an auxiliary sensing area 204. In the illustrated embodiment, the virtual keys 203 include a left key 203-1, a middle key 203-2, and a right key 203-3. However, as explained above, the present disclosure is not limited to a touch panel having three virtual keys. The number of virtual keys may be more or less than three. The auxiliary sensing area 204 is located at one side of the touch panel 201. In the illustrated embodiment, the auxiliary sensing area 204 is disposed to the further right of the right key 203-3.

The touch processing circuit 202 is coupled with the touch panel 201 and configured to process triggers of the virtual keys 203 and the auxiliary sensing area 204. In one embodiment, the touch processing circuit 202 processes triggers of the virtual keys 203-2 and 203-3 and the auxiliary sensing area 204 when they are touched in a single track or gesture motion of a user. The touch processing circuit 202 may be a dedicated electronic chip for processing signals generated from touching the virtual keys 203, or may be a general-purpose processing chip, such as a CPU of the mobile terminal 200. The touch processing circuit 202 may be integrated with other electronic chips of the mobile terminal 200. For illustrative purposes only, the touch processing circuit 202 is shown in FIG. 2 to be outside of the mobile terminal 200.

As shown in FIG. 2, the auxiliary sensing area 204 is located on the right side of the virtual keys 203. If the user uses his/her right hand to hold the mobile terminal 200 and wishes to touch the middle key 203-2 using a finger of his/her right hand, it is likely that all of the middle key 203-2, the right key 203-3, and the auxiliary sensing area 204 are touched and triggered. The touch processing circuit 202 receives three triggering signals respectively from the middle key 203-2, the right key 203-3, and the auxiliary sensing area 204. In this case, the touch processing circuit 202 is configured to process the selection of a key that is touched and located the farthest from the auxiliary sensing area 204. In the illustrated embodiment, although both keys 203-2 and 203-3 are triggered, the auxiliary sensing area 204 processes the selection of the middle key 203-2 first because a distance between the middle key 203-2 and the auxiliary sensing area 204 is greater than a distance between the right key 203-3 and the auxiliary sensing area 204. This configuration may reduce incorrect processing caused by incorrectly touching a key. Therefore, the selection of the virtual keys may be processed more accurately.

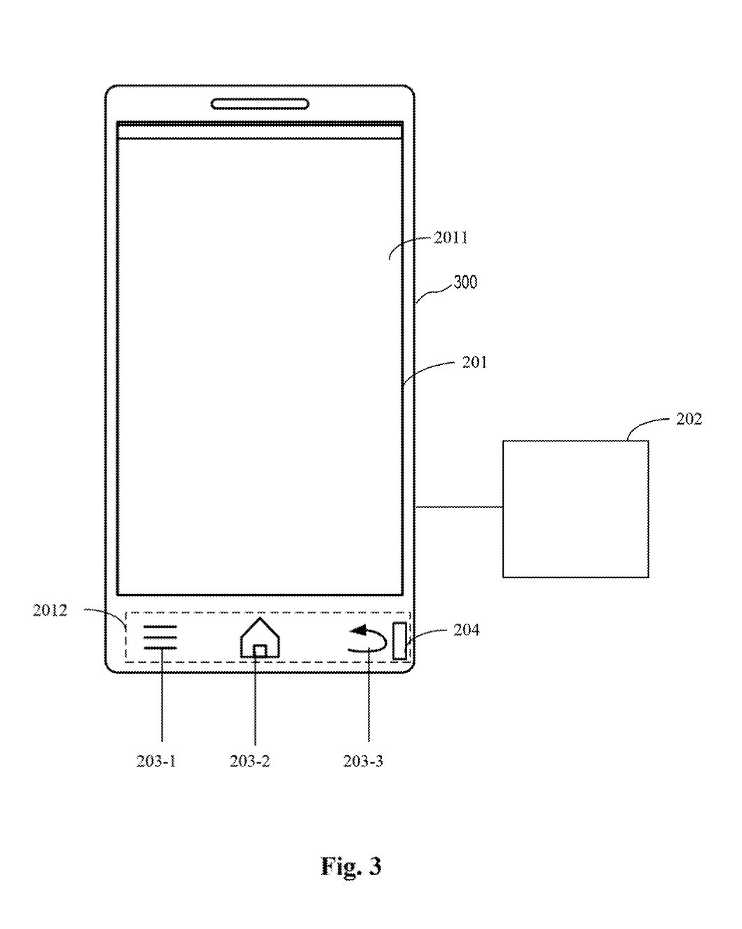

FIG. 3 shows another exemplary mobile terminal 300 consistent with embodiments of the present disclosure. The mobile terminal 300 has the same configuration as the mobile terminal 200, except that the touch panel 201 of mobile terminal 300 includes an interface area 2011 and a control area 2012. The virtual keys 203 and the auxiliary sensing area 204 are located in the control area 2012. The virtual keys 203 may include menu keys, a home key, a back key, etc.

The auxiliary sensing area 204 may assist a selection in the interface area 2011 as well as in the control area 2012 of the touch panel 201. For example, multiple locations in the interface areas 2011 are touched in one track of user's finger movement. The touch processing circuit 202 is configured to process the selection of a location in the interface area 2011 that is located the farthest from the auxiliary sensing area 204. In one embodiment, processing by the touch processing circuit 202 is more effective if the triggering events come from the control area 2012.

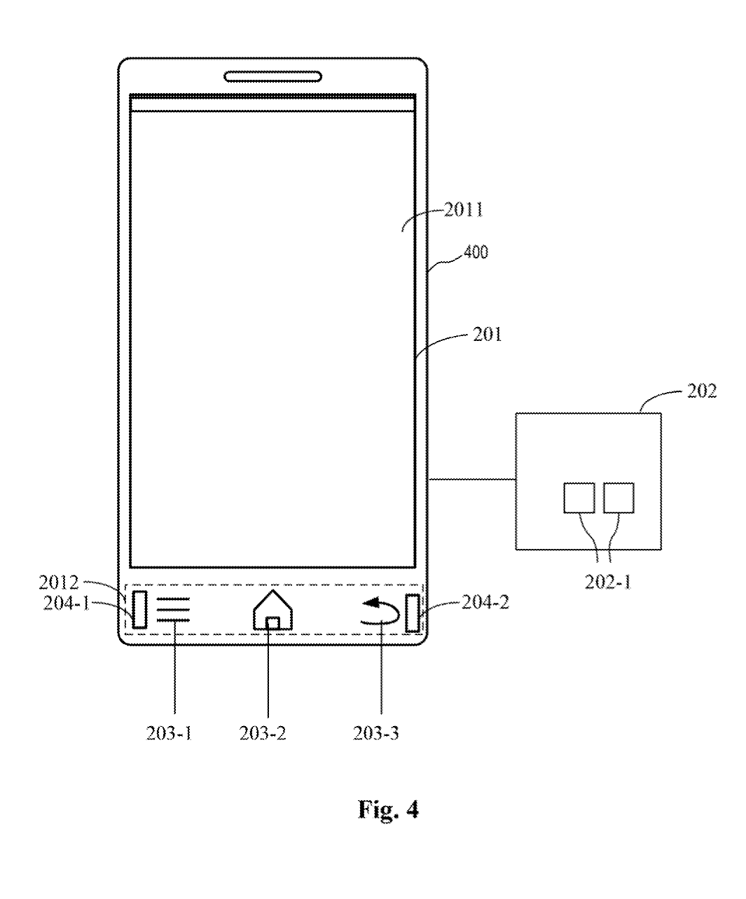

FIG. 4 shows yet another exemplary mobile terminal 400 consistent with embodiments of the present disclosure. As shown in FIG. 4, the configuration of the mobile terminal 400 is the same as that of the mobile terminal 300, except that mobile terminal 400 includes two auxiliary sensing areas 204-1 and 204-2. In the illustrated embodiment, the auxiliary sensing areas 204-1 and 204-2 are located on the far left and far right in the control area 2012. Specifically, the auxiliary sensing area 204-1 is disposed to the left of the left key 203-1 and the auxiliary sensing area 204-2 is disposed to the right of the right key 203-3. In some embodiments, the auxiliary sensing areas 204-1 and 204-2 are disposed to be aligned with the virtual keys 203.

The mobile terminal 400 may be particularly useful since a user may be left-handed or right-handed. A user may be accustomed to hold a mobile terminal with his/her left hand, and another user may be accustomed to hold a mobile terminal with his/her right hand. For example, if the user holds the mobile terminal 400 with his/her left hand and touches the virtual keys using a finger of his/her left hand, the auxiliary sensing area 204-1 located on the left side of the control area 2012 is activated. When a finger of the user's left hand is intended to touch the middle key 203-2, both the left key 203-1 and the auxiliary sensing area 204-1 located on the left side may be touched. Then the touch processing circuit 202 may ignore signals generated from touching the left key 203-1 and directly process the trigger of the middle key 203-2. Such a configuration not only reduces the possibility of processing the incorrect triggering but also the time required to process the user selection.

If the user holds the mobile terminal 400 with his/her right hand and touches the virtual keys 203 using a finger of his/her right hand, the auxiliary sensing area 204-2 located on the right side of the control area 2012 is activated. When a finger of the user's right hand is intended to touch the middle key 203-2, both the right key 203-3 and the auxiliary sensing area 204-2 located on the right side may be touched. Then the touch processing circuit 202 may ignore signals generated from touching the right key 203-3 and directly process the trigger of the middle key 203-2.

In some embodiments, when the auxiliary sensing area 204-1 located on the left side is triggered, the priority of the virtual keys from high to low is: the right key 203-3, the middle key 203-2, and the left key 203-1. That is, the signals generated from touching the virtual keys 203 are processed in an order according to how far a virtual key is located relative to the location of the auxiliary induction area 204-1 located at the left side. Thus, the triggering of a virtual key located farthest from the activated auxiliary sensing area takes priority of triggering of other keys located closer to the auxiliary sensing area. Similarly, when the auxiliary sensing area 204-2 located on the right side is triggered, the priority of the virtual keys from high to low is: the left key 203-1, the middle key 203-2, and the right key 203-3. The triggering of the left virtual key 203-1 located farthest from the activated auxiliary sensing area 204-2 takes priority of triggering of the other keys. In some embodiments, only the signal from the highest priority virtual key is processed. Signal(s) from the other low priority virtual keys may be ignored and not processed.

The mobile device 400 thus may accommodate the users with different handedness. In some embodiments, one or more auxiliary sensing areas may be added to the touch panel according to different needs, so as to process the selection on virtual keys more accurately. For example, one or more auxiliary sensing areas may be added to the interface area 2011 to facilitate processing of selection from the interface area 2011.

In one embodiment, referring to FIG. 4, the touch processing circuit 202 may include one or more comparators 202-1. Each comparator 202-1 is configured to receive a touch sensing signal for one virtual key and determine whether an intensity of the touch sensing signal is greater than a predetermined intensity threshold. If the intensity of the touch sensing signal is greater than the predetermined intensity threshold, the comparator 202-1 determines that the touch corresponding to the touch sensing signal constitutes a trigger. If the intensity of the touch sensing signal is not greater than the intensity threshold, the comparator 202-1 determines that the touch corresponding to the touch sensing signal does not constitute a trigger of the virtual key and is ignored.

The illustrated configuration may identify the trigger of the touch sensing signal more accurately via the use of the comparators, such that the incorrect processing caused by the false touching may be reduced.

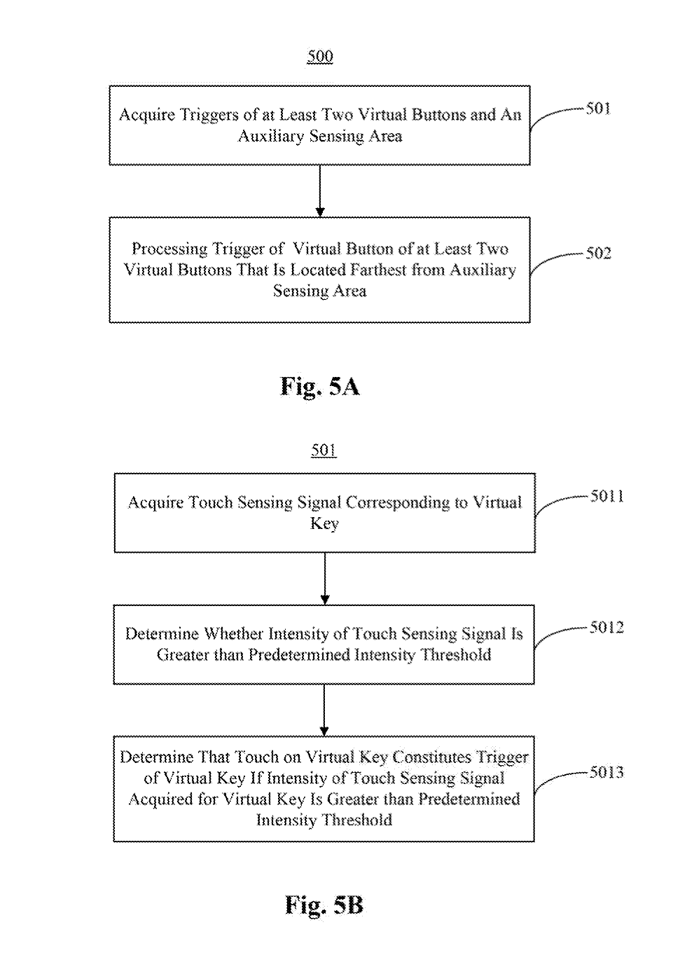

FIG. 5A is a flow chart showing a method 500 for processing signals from touching virtual keys according to an exemplary embodiment of the present disclosure. The method 500 may be performed by a mobile terminal, such as mobile terminals 200, 300, and 400 shown in FIGS. 2, 3, and 4, respectively. As shown in FIG. 5A, the method 500 includes the following steps.

In step 501, triggers of at least two virtual keys and an auxiliary sensing area are simultaneously acquired. For example, the triggers are acquired within a short, predetermined period of time.

In step 502, a trigger of a virtual key of the at least two virtual keys that is located farthest from the auxiliary sensing area is processed. The trigger from the other virtual key(s) is ignored and not processed.

In some embodiments, referring to FIG. 5B, the step 501 includes steps 5011-5013. In step 5011, a touch sensing signal corresponding to a virtual key is acquired. In Step 5012, whether an intensity of the touch sensing signal is greater than a predetermined intensity threshold is determined. In step 5013, if the intensity of the touch sensing signal acquired for the virtual key is greater than the predetermined intensity threshold, it is determined that the touch on the virtual key constitutes a trigger of the virtual key.

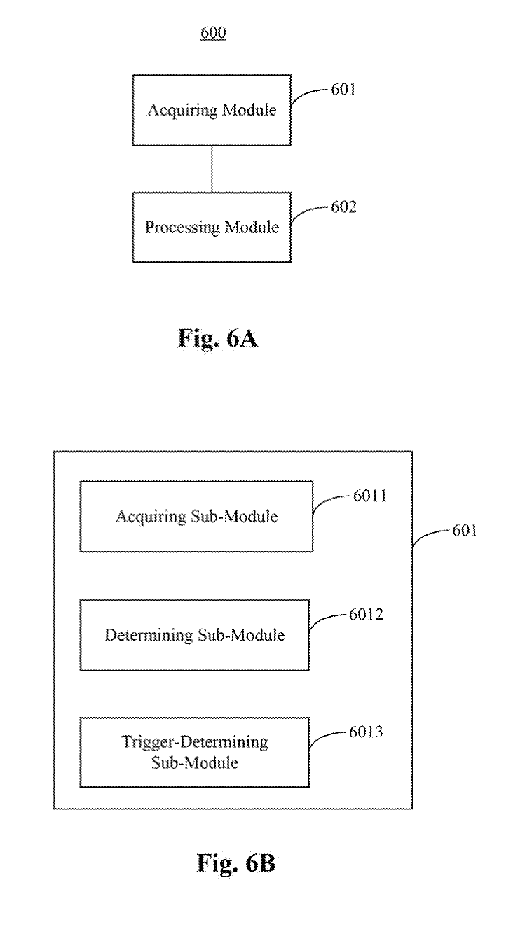

FIG. 6A is a block diagram showing a device 600 for processing signals generated from touching virtual keys according to an example embodiment of the present disclosure. The device 600 may be a mobile terminal, such as the mobile terminal 200, 300, or 400. As shown in FIG. 6, the device 600 includes an acquiring module 601 and a processing module 602.

The acquiring module 601 is configured to simultaneously acquire triggers of at least two virtual keys and an auxiliary sensing area of a touch panel. For example, the triggers are acquired within a short, predetermined period of time.

The processing module 602 is configured to process a trigger of a virtual key of the at least two virtual keys that is located farthest from the auxiliary sensing area. In some embodiments, the processing module 602 ignores and does not process the trigger from the other virtual key that is located closer to the auxiliary sensing area.

In one embodiment, referring to FIG. 6B, the acquiring module 601 includes an acquiring sub-module 6011, a determining sub-module 6012, and a trigger-determining sub-module 6013.

The acquiring sub-module 6011 is configured to acquire a touch sensing signal for a virtual key.

The determining sub-module 6012 is configured to determine whether an intensity of the touch sensing signal is greater than a predetermined intensity threshold.

The trigger-determining sub-module 6013 is configured to determine that the touch on the virtual key constitutes a trigger of the virtual key if the intensity of the touch sensing signal obtained for the virtual key is greater than the predetermined intensity threshold.

With respect to the devices in the above embodiments, the specific manners for performing operations or functions of individual modules and sub-modules therein have been described in detail in the description of the method 500 and mobile terminals 200, 300, and 400, which are not repeated herein.

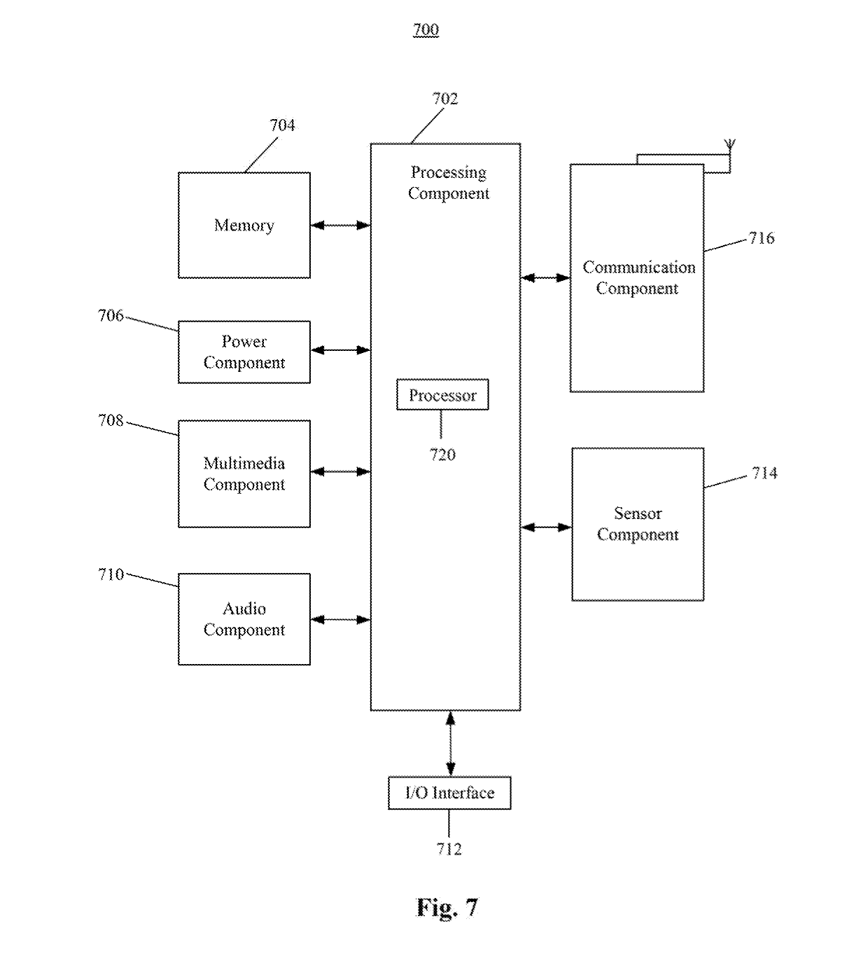

FIG. 7 is a block diagram showing a mobile terminal 700 according to an exemplary embodiment of the present disclosure. For example, the mobile terminal 700 may be a mobile phone, a computer, a digital broadcast terminal, a messaging device, a gaming console, a tablet, a medical device, exercise equipment, a personal digital assistant, and the like.

Referring to FIG. 7, the device 700 may include one or more of the following components: a processing component 702, a memory 704, a power component 706, a multimedia component 708, an audio component 710, an input/output (I/O) interface 712, a sensor component 714 and a communication component 716.

The processing component 702 typically controls overall operations of the device 700, such as the operations associated with display, telephone calls, data communications, camera operations, and recording operations. The processing component 702 may include one or more processors 720 to execute instructions so as to perform all or a part of the steps in the above described methods. Moreover, the processing component 702 may include one or more modules which facilitate the interaction between the processing component 702 and other components. For instance, the processing component 702 may include a multimedia module to facilitate the interaction between the multimedia component 708 and the processing component 702.

The memory 704 is configured to store various types of data to support the operation of the device 700. Examples of such data include instructions for any applications or methods operated on the device 700, contact data, phonebook data, messages, pictures, videos, etc. The memory 704 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 706 is configured to provide power to various components of the device 700. The power component 706 may include a power management system, one or more power sources, and other components associated with the generation, control, and distribution of power in the device 700.

The multimedia component 708 includes a screen configured to provide an output interface between the device 700 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 708 includes a front camera and/or a rear camera. The front camera and the rear camera may receive an external multimedia datum when the device 700 is in an operation mode such as a photographing mode or a video mode. Each of the front camera and the rear camera may be a fixed optical lens system or have focus and optical zoom capability.

The audio component 710 is configured to output and/or input audio signals. For example, the audio component 710 includes a microphone (“MIC”) configured to receive an external audio signal when the device 700 is in an operation mode, such as a call mode, a recording mode, and a voice recognition mode. The received audio signal may be further stored in the memory 704 or transmitted via the communication component 716. In some embodiments, the audio component 710 further includes a loud speaker to output audio signals.

The I/O interface 712 is configured to provide an interface between the processing component 702 and peripheral interface modules, such as a keyboard, a click wheel, keys, and the like. The keys may include, but are not limited to, a home key, a volume key, a starting key, and a locking key.

The sensor component 714 includes one or more sensors to provide status assessments of various aspects of the device 700. For instance, the sensor component 714 may detect an on/off status of the device 700, relative positioning of components (e.g., a display screen and a keypad) of the device 700. The sensor component 714 may further detect a change in position of the device 700 or a component of the device 700, a presence or absence of user contact with the device 700, an orientation or an acceleration/deceleration of the device 700, and a change in temperature of the device 700. The sensor component 714 may include a proximity sensor configured to detect the presence of nearby objects without any physical contact. The sensor component 714 may further include a light sensor, such as a CMOS or CCD image sensor, for use in imaging applications. In some embodiments, the sensor component 714 may also include an accelerometer sensor, a gyroscope sensor, a magnetic sensor, a pressure sensor, or a temperature sensor.

The communication component 716 is configured to facilitate a wired or wireless communication between the device 700 and other terminals. The device 700 can access a wireless network based on a communication standard, such as WiFi, 2G, or 3G, or a combination thereof. In one exemplary embodiment, the communication component 716 receives a broadcast signal or broadcast associated information from an external broadcast control system via a broadcast channel. In one exemplary embodiment, the communication component 716 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, or other technologies.

In exemplary embodiments, the device 700 may be implemented with one or more electronic elements such as application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is further provided a non-transitory computer readable storage medium including instructions, such as the memory 704 including instructions executable by the processor 720 in the device 700 to perform the above-described methods. For example, the non-transitory computer-readable storage medium may be a ROM, a RAM, a CD-ROM, a magnetic tape, a floppy disc, an optical data storage device, and the like.

One of ordinary skill in the art will understand that the above described modules can each be implemented by hardware, or software, or a combination of hardware and software. One of ordinary skill in the art will also understand that multiple ones of the above described modules may be combined as one module, and each of the above described modules may be further divided into a plurality of sub-modules.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A mobile terminal, comprising:
a touch panel including a plurality of virtual keys and a first auxiliary sensing area, wherein the first auxiliary sensing area is located on one side of the touch panel; and
a touch processing circuit coupled to the touch panel, the touch processing circuit being configured to receive triggers of at least two virtual keys and the first auxiliary sensing area and process a trigger of a first one of the at least two virtual keys that is located farther away from the first auxiliary sensing area.

2. The mobile terminal according to claim 1, wherein the touch panel includes an interface area and a control area, and the plurality of virtual keys are located in the control area of the touch panel.

3. The mobile terminal according to claim 2, wherein the touch panel includes a second auxiliary sensing area, the first and second auxiliary sensing areas respectively located on first and second sides of the control area.

4. The mobile terminal according to claim 1, wherein the touch processing circuit comprises a comparator configured to:
acquire a touch sensing signal for a virtual key of the plurality of virtual keys;
determine whether an intensity of the touch sensing signal is greater than a predetermined intensity threshold; and
determine that a touch on the virtual key constitutes a trigger of the virtual key if the intensity of the touch sensing signal acquired for the virtual key is greater than the predetermined intensity threshold.

5. A method for processing signals generated from touching virtual keys of a touch panel, comprising:
acquiring triggers of at least two virtual keys and an auxiliary sensing area of the touch panel; and
processing a trigger of a first one of the at least two virtual keys that is located farther away from the auxiliary sensing area.

6. The method according to claim 5, wherein the acquiring triggers of the at least two virtual keys comprises:
acquiring a touch sensing signal for a virtual key of the virtual keys;
determining whether an intensity of the touch sensing signal is greater than a predetermined intensity threshold; and
determining that a touch on the virtual key constitutes a trigger of the virtual key if the intensity of the touch sensing signal acquired for the virtual key is greater than the predetermined intensity threshold.

7. A device for processing signals generated from touching virtual keys of a touch panel, the device comprising:
a processor; and
a memory for storing instructions executable by the processor;
wherein the processor is configured to:
acquire triggers of at least two virtual keys and an auxiliary sensing area of the touch panel; and
process a trigger of a first one of the at least two virtual keys that is located farther away from the auxiliary sensing area.

8. The device according to claim 7, wherein the processor is configured to acquire triggers of the at least two virtual keys and the auxiliary sensing area by:
acquiring a touch sensing signal for a virtual key of the virtual keys;
determining whether an intensity of the touch sensing signal is greater than a predetermined intensity threshold; and
determining that a touch on the virtual key constitutes a trigger of the virtual key if the intensity of the touch sensing signal acquired for the virtual key is greater than the predetermined intensity threshold.
